(19) United States
(12) Patent Application Publication
(10) Pub. No.: US 2025/0259993 A1
(43) Pub. Date: Aug. 14, 2025

(54) MECHANICALLY STABILIZED DUAL-SOURCED SULFUR ELECTRODES

(71) Applicant: Zeta Energy Corporation, Houston, TX (US)

(72) Inventors: Rodrigo Villegas Salvatierra, Houston, TX (US); Binbin Qi, Houston, TX (US); Sasidharan Prakasan, Tomball, TX (US); Abdul-Rahman Olabode Raji, Houston, TX (US); Jianan Xu, Houston, TX (US); Rodrigo Elizalde Segovia, Houston, TX (US)

(21) Appl. No.: 19/036,443

(22) Filed: Jan. 24, 2025

Related U.S. Application Data
(60) Provisional application No. 63/553,048, filed on Feb. 13, 2024.

(51) Int. Cl. H01M 4/36; H01M 4/02; H01M 4/587

(52) U.S. Cl. CPC H01M 4/364; H01M 4/587; H01M 2004/021

(57) ABSTRACT

Described are electrodes composed of a carbonaceous matrix with sulfurized carbon particles. These particles feature sulfur atoms covalently bonded to carbon atoms, internal pores, and sulfur molecules both adsorbed and contained within these pores. The structure includes electrically conductive filaments and particle agglomerates fused to a subset of these filaments, which possess specific length and width dimensions and extend as anchor segments to connect adjacent particles. Additionally, the electrode incorporates yarns made from a second subset of filaments, characterized by lengths and widths exceeding those of the initial filaments, spanning between the particle agglomerates. The resultant electrode shows unique electrochemical behavior that enhances its energy density over other carbonaceous sulfurized carbon materials.

### CROSS REFERENCE TO RELATED APPLICATION

This application claims priority to U.S. Provisional Patent Application 63/553,048 entitled “Dual-Source Sulfur Electrodes” filed 13 Feb. 2024 and incorporated herein by reference.

### BACKGROUND

An electric battery includes one or more electrochemical cells. Each cell includes a positive electrode (cathode) and a negative electrode (anode) physically separated by an ion conductor (electrolyte). When a cell is discharged to power an external circuit, the anode supplies negative charge carriers (electrons) to the cathode via the external circuit and positive charge carriers (cations) to the cathode via the internal electrolyte. During charging, an external power source drives electrons from the cathode to the anode and cations from the cathode through the electrolyte and to the anode.

Electrodes commonly combine active and passive materials, active material being what reacts chemically to store and produce electrical energy when the cell charges and discharges. The passive material binds the active material and can contribute to thermal and electrical conductivity. Active and passive materials can be combined using wet- or dry-electrode processes. Wet processes deposit electrode materials as a slurry that must then be treated and dried. Managing solvents and the area and time required for drying are disadvantageous. Dry-electrode processes avoid these issues.

In typical dry-electrode processing, a mixture of an active material, a conductive additive, and a polymeric binder are processed to the point of forming a powder. The powder can then be compressed and laminated over a conductive surface, such as a current collector of a metal foil.

### BRIEF DESCRIPTION OF THE DRAWINGS

The present invention is illustrated by way of example, and not by way of limitation, in the figures of the accompanying drawings and in which like references refer to similar elements and in which:

FIG. 1 is a flowchart depicting a dry-electrode process for creating a cathode of an electrochemical cell in accordance with one embodiment.

FIG. 2 is a SEM image of a 590×512-micron area of a free-standing SC film 200 in accordance with one embodiment.

FIG. 3 is a bar chart 300 in which each bar relates a number of yarns 220 of a range of lengths in the image of FIG. 2.

FIG. 4 is a SEM image 400 of SC film 200 of FIG. 2 under higher magnification.

FIG. 5 is a SEM image 500 of SC film 200 of FIGS. 2 and 4 under still higher magnification.

FIG. 6 is a SEM image 600 of SC film 200 of FIGS. 2, 4, and 5 under still higher magnification.

FIG. 7 is a SEM image 700 of SC film 200 of FIGS. 2, 4, 5, and 6 under still higher magnification.

FIG. 8 includes a diagram 800 illustrating sulfurized-carbon structures 805 with covalently bonded sulfur 810, an illustrative sulfur molecule 815 trapped in a pore 817 of the sulfurized carbon, and a thermogravimetric analysis 820 characterizing sulfurized carbon material with bonded and trapped sulfur.

FIG. 9 is a chart 900 showing the thermal gravimetric analysis (TGA) of elemental sulfur and sulfurized carbon samples (denoted with solid lines) and the dual-sourced sulfur samples (denoted with dot and dashed lines).

FIG. 10 is a chart 1000 showing the galvanostatic discharge curves voltage vs specific capacity of the sulfurized carbon baseline (denoted with a solid line) and variation of dual-sourced sulfur samples (denoted with dot and dashed lines).

### DETAILED DESCRIPTION

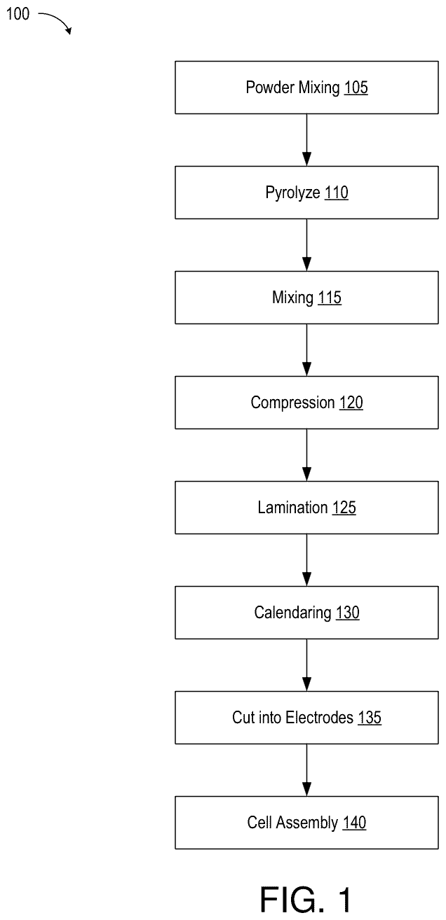

FIG. 1 is a flowchart depicting a dry-electrode process for creating a cathode of an electrochemical cell in accordance with one embodiment. First, at step 105, powders containing >80% sulfur, a polymer precursor, and bundles of carbon nanotubes (CNTs) are mixed. The CNTs can be in the form of yarns or bundles, with lengths in the order of hundreds or thousands of microns. In addition to the hundreds or thousands of microns in length, these CNT yarns can be interconnected, forming a macroscopic web-like structure. CNT yarns can consist of CNTs that are bundled in parallel and can ramify into multiple branches, contributing to the web-like structure. CNTs can include species with lengths between fifty and one hundred microns and widths between five and one hundred nanometers.

In one example of step 105, powders of sulfur, a polymer, carbon nanomaterials including CNTs, and CNT yarns are mixed in a mass ratio of e.g. 22:11:5:5. The sulfur powder is mixed with a powder of poly(acrylonitrile-co-vinyl acid), or PAN, with an average molecular weight of 150,000 Dalton; CNTs between fifty and one hundred microns long and between five and one hundred nanometers wide; and CNT yarns hundreds or thousands of microns long. The mixing yields a fluffy powder comprising the CNT yarns. The mixing of CNTs with CNT yarns and other components can be conducted with an impeller or methods such as ball or jet milling. The mixing yields a fluffy powder comprising the CNT yarns and agglomerates of the multiwall CNTs intermixed with sulfur and polymer.

The fluffy powder is pyrolyzed (at step 110) in a furnace at temperatures between 300 and 500°° C. Pyrolyzation carbonizes the polymer precursor by driving off constituent hydrogen and nitrogen and incorporating sulfur. In some preparations, a polymer precursor is from the family of polyacrylonitrile. The filaments—multi-wall CNTs and CNT yarns—tend to fuse to the resulting SC particles and agglomerates. The bulk of the smaller CNTs is entrapped within and between the SC powder particles, whereas the bulk of the CNT yarns are outside the agglomerates. The CNT yarns can ramify during mixing and the resultant CNT branches and fragments can be entrapped within the agglomerates with the other smaller CNTs. Some of the smaller CNTs trapped within SC particles have anchor segments that extend beyond their particles, and some of those form crosses, hooks, loops, kinks, and elbows that interlace with anchor segments from adjacent particles.

Next, in step 115, the pyrolyzed material is mixed using a high-shear mixer. The mixing loosens the agglomerates and exposes CNTs and yarn extensions that are fused to the particles and agglomerates. The resultant “fuzz” on and between the SC particles and what remains of the agglomerates gives the resultant powder a fluffy, clumpy consistency and a very high angle of repose. This fluffy powder can be further ground and sieved to select agglomerates and collections of agglomerates of a pre-determined size or sizes. The mixing process of step 115 can add a polymer binder, carbon additives, or both, that accounts for between one and ten percent of the total mass of the fluffy powder. In one embodiment, the mixing step of 115 adds three weight percent of a polymer binder, such as polyvinylidene difluoride (PVDF). The concentration of the polymer binder can be less than one weight percent or can be omitted entirely.

In other methods of preparation, the mixing step of 115 can add additional active material, such as a solid electrolyte powder or powders. The solid electrolyte can be at least one of garnet-type oxides, lithium-based NASICON solids, LISICON solids, Li-containing antiperovskite, lithium thiophosphates, lithium phosphate oxynitrides, glassy sulfide compounds, and compounds thereof. The electrolyte powder can be 20 wt % to 60 wt % of the total mass.

The pyrolyzed powder is compressed (120) between parallel rollers to produce a self-supporting SC film in which the CNT yarns form an electrically conductive, three-dimensional network that aids mechanical stability. The SC film can be free-standing. The yarn fragments range from hundreds to thousands of microns in length and lack well-defined aspect ratios. Some films include yarn fragments that extend entirely through the thickness of the film. The smaller CNTs have relatively well-defined aspect ratios and tend to extend within individual SC agglomerates, sometimes bridging agglomerates, providing connectivity that is short ranged in comparison to the network of CNT yarn.

In another embodiment, the fluffy SC powder is conveyed into a roll nip and pressed between two parallel rollers operating at different rotational speeds. A dry film of interconnected agglomerates is formed on the faster rotating roll. The film can be transferred from this faster roll to a target substrate by lamination. A suitable dry-electrode process is described in B. Schumm and S. Kaskel, “Dry battery electrode processing, what's next?”, Next Energy, https://doi.org/10.1016/j.nxener.2023.100009, which is incorporated herein by reference.

The free-standing film can be stacked or rolled for later use, or can be immediately transferred to a substrate, such as a current collector for an electrochemical cell. For example, the free-standing film can be laminated on one or both sides of an aluminum current collector to form a cathode (125). The resulting laminate is then compacted, smoothed, and finished by calendaring (130). CNT anchor segments that extend beyond their particles to form entangled loops and kinks in the powder appear as superimposed crossing filaments in the calendared cathode material.

Forming the film prior to lamination and calendaring allows the compression, lamination, and calendaring steps to be optimized separately. For example, compaction at a pressure optimized for high cathode density may be too high for effective lamination. Other embodiments combine one or more of steps 120, 125, and 130. The laminated and calendared cathode material is cut into electrodes (135) and combined with other cell components during cell assembly (130).

Most of the sulfur atoms in the SC cathode material are bonded to an adjacent carbon atom via a relatively strong, covalent, carbon-sulfur bond. In some embodiments, essentially all of the sulfur atoms in the agglomerates are bonded to carbon either directly or via chains of covalently bonded sulfur atoms, though some may be unbonded during cycling (i.e., moving charge carriers into and out of the cathode).

The pyrolyzed powder from step 110 can also be used in a wet process. For example, the pyrolyzed powder can be mixed with a powdered carbon, such as acetylene black, a polymer binder, and an organic solvent or water to form a slurry. The binder and carbon additive can compose from 5 to 20% in weight of the solid mass. The slurry is then spread over one or both sides of e.g. an aluminum foil that will serve as a current collector. The slurry-coated foil is then dried and compressed.

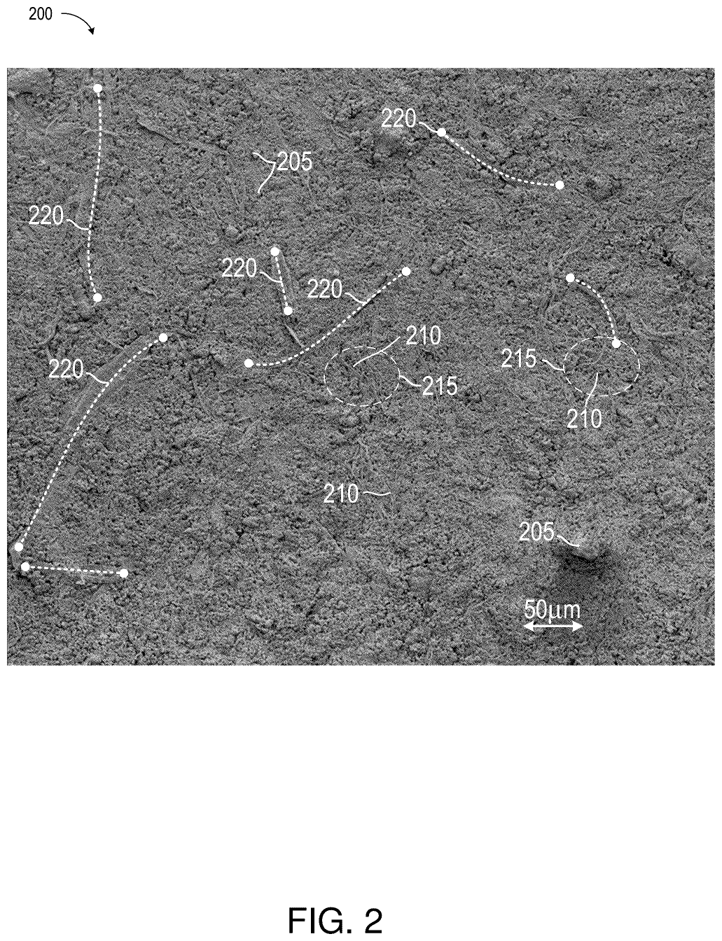

FIG. 2 is a SEM image of a 590×512-micron area of a free-standing SC film 200 in accordance with one embodiment. The material is a compacted solid in which much of the internal structure is obscured by compacted SC agglomerates 205. CNT filaments 210, notable due to their relatively small and uniform cross sections, are exposed in some areas 215. Larger CNT yarns 220 are highlighted using dashed lines that roughly trace their paths. CNT yarns 220 are longer, wider, and less uniform than CNT filaments 210. The CNT filaments and yarns extend both in the plane of the film, as shown, and normal to the plane, collectively forming a conductive, three-dimensional framework of nanofibers in physical and electrical contact with SC particles formed into agglomerates 205.

In the example of SC film 200, CNT yarns 220 have a maximum width of at least three microns, with some being considerably larger. The distributions of CNT filaments and yarns are spread out in the 3D space of film 200 with vertical filaments, yarns, and sections of filaments and yarns obscured. Yarns 220 of CNT filaments can range from hundreds to thousands of microns in length and have no defined aspect ratio. Yarns 220 extend between more local networks of CNT filaments 210. The bulk of CNT filaments 210 are intra-agglomerate filaments, whereas the bulk of CNT yarns 220 are extra-agglomerate filaments that extend past and are fused to multiple agglomerates.

The dimensions of the particles, agglomerates, intra-agglomerate filaments, and extra-agglomerate filaments can be specified relative to one another. The intra-agglomerate filaments are within the agglomerates and thus have an average intra-agglomerate-filament width less than the average agglomerate size, less than the average particle size in some embodiments. The extra-agglomerate filaments have an average extra-agglomerate-filament width greater than the average intra-agglomerate-filament width and an average extra-agglomerate length greater than the average agglomerate size. The average extra-agglomerate-filament length is greater than five times the average agglomerate size in some embodiments.

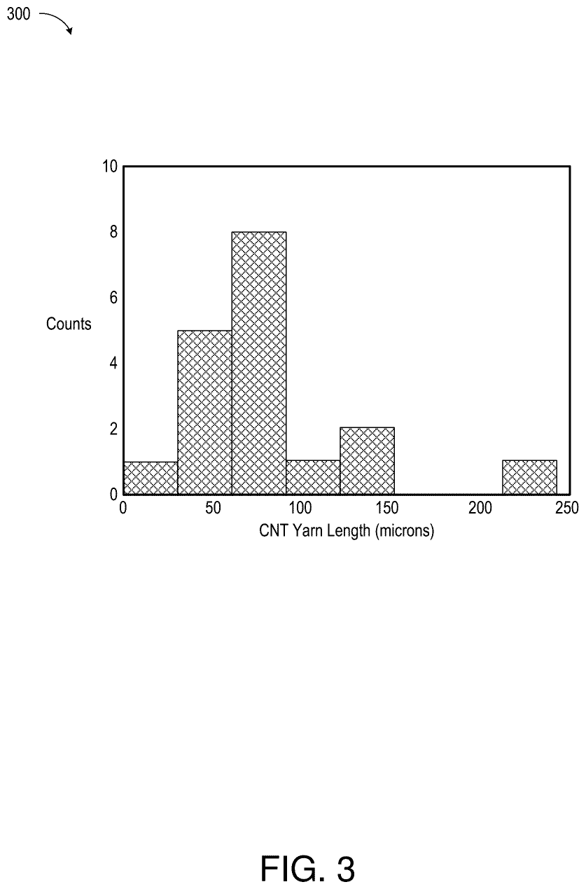

FIG. 3 is a bar chart 300 in which each bar relates a number of yarns 220 of a range of lengths in the image of FIG. 2. The 590×512-micron sample area gives a sense of the relative proportions of yarn lengths in film 200. Most yarns 220 are between fifty and one hundred fifty microns. Many are considerably longer than the CNT precursors used in the method of FIG. 1 to form film 200.

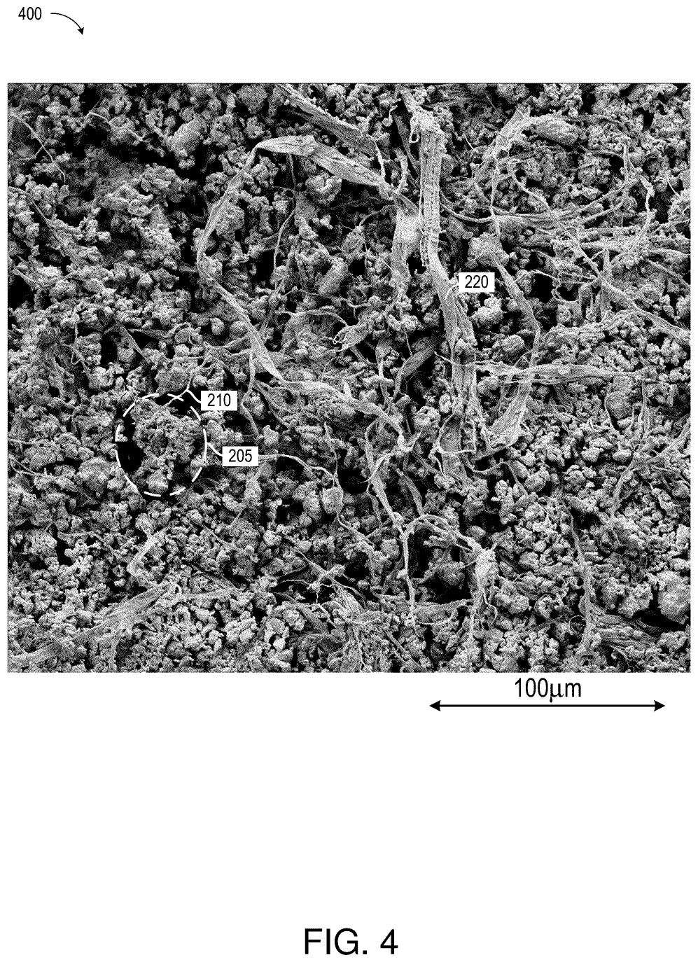

FIG. 4 is a SEM image 400 of SC film 200 of FIG. 2 under higher magnification. Agglomerates 205 of particles are seen with CNTs 210 within and between the agglomerates. Segments of the larger CNT yarns 220 tend to extend far longer than the average size of agglomerates 205, physically and electrically connecting the agglomerates and their constituent SC particles and CNTs. In the context of particles and agglomerates, “size” refers to the largest dimension.

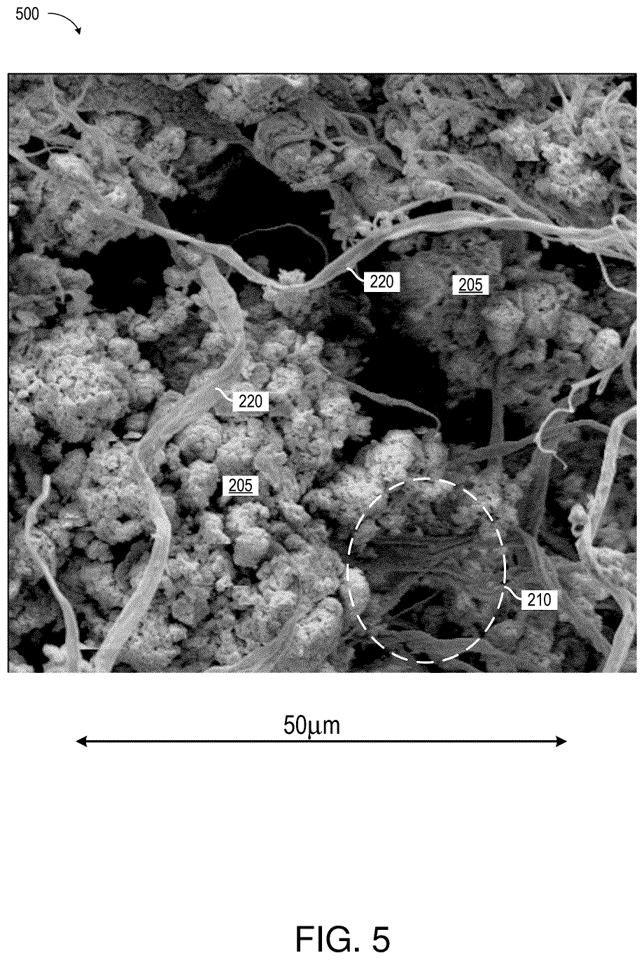

FIG. 5 is a SEM image 500 of SC film 200 of FIGS. 2 and 4 under still higher magnification. A collection of CNTs 210 encircled at lower right extends from agglomerates 205. The bulk of the CNT filaments are embedded within agglomerates 205, whereas the bulk of CNT yarns 220 are threaded between them. Electrically, CNTs 210 serve as feeder lines, short-range conductors that connect SC particles within agglomerates 205 to CNT yarns 220. The CNT yarns, in turn, serve as trunk lines, long-range conductors that connect the feeder lines to a current collector (e.g. a metal film). The resultant three-dimensional conductive framework binds the SC particles and agglomerates while providing low-resistance electrical connectivity between the SC particles and the current collector. The three-dimensional framework also mechanically supports the electrode structure.

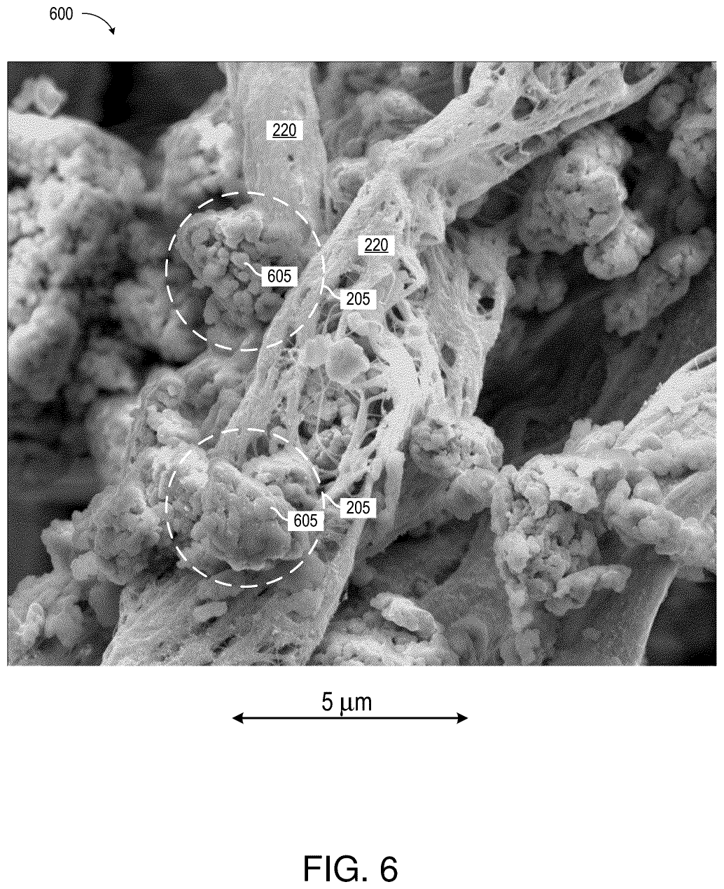

FIG. 6 is a SEM image 600 of SC film 200 of FIGS. 2, 4, and 5 under still higher magnification. SC particles 605 are easily discernable constituents of agglomerates 205. CNTs extend through particles 605 generally but are not visible. The widths of CNT yarn fragments 220 are greater than the average size of particles 605 and are on the order of the average size of agglomerates 205. CNTs 210, on the order of ten nanometers in diameter in the depicted sample, are difficult to image and thus hidden from view. Yarn fragments 220 can partially disentangle during mixing 115 leaving smaller fragments that get incorporated into agglomerates 205 with CNTs 210. However, the bulk of the material introduced as yarns in mixing 105 remains outside the agglomerates. Some of the yarns can be seen to comprise carbon filaments that branch and recombine at joints.

The conductive filaments have bimodal distributions of lengths and widths selected in proportion to the sizes of agglomerates 205 and particles 605. The CNTs are relatively thin so that mixing and milling tend to combine the CNTs with SC particles 605 to form agglomerates 205. Yarns 220 are much thicker than the CNTs and tend to remain outside of particles 605 and agglomerates 205 during mixing and milling.

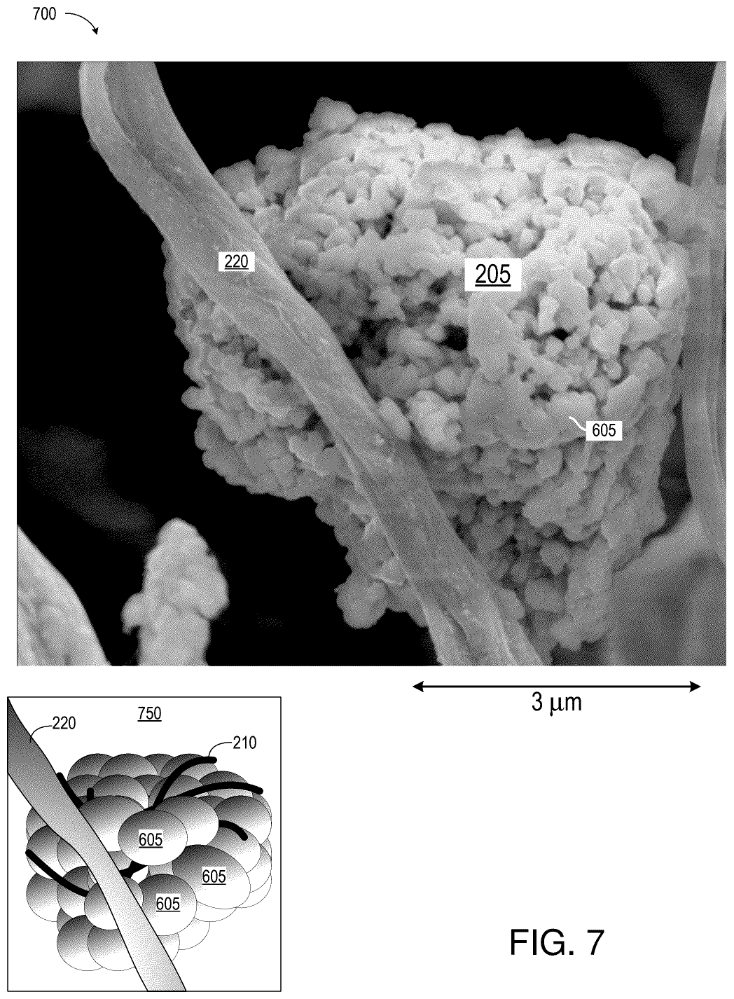

FIG. 7 is a SEM image 700 of SC film 200 of FIGS. 2, 4, 5, and 6 under still higher magnification. SC particles 605 are easily discernable constituents of an agglomerate 205. A CNT yarn fragment 220 extends past an agglomerate 205. A graphic 750 at bottom highlights SC particles 605 and CNTs 210.

The conductive filaments are multi-wall CNTs and CNT yarns in the forgoing embodiments. Other embodiments can include more or different combinations of conductive filaments, including e.g. SC fibers. Conductive additives of e.g. graphene, graphite, nanoplatelets, nanorods, and nanoribbons can be used with or instead of CNTs and/or CNT yarns. Selenium can be used with or instead of sulfur to produce particles and agglomerates of sulfurized/selenized carbon or selenized carbon.

Sulfur-based cathodes can be limited in use by the depletion of active material from the cathode electrode, known as the shuttle effect. The shuttle of active materials happens because specific products of discharge, lithium polysulfides (LiPS), present solubility in the battery electrolyte thus leaching out from the physical structure of the cathode. This effect is enhanced by the poor adsorption of sulfur crystals over a conductive matrix, typically of carbon. In the above-described sulfurized-carbon synthesis, sulfur molecules react with decomposing carbon-based materials, forming new bonds between sulfur molecules and the derived carbon material. The resulting sulfurized carbon presents excellent stability even in carbonate-based electrolytes, which are not compatible with elemental sulfur-based cathodes because of their inherent reactivity.

Sulfurized carbon materials are limited by the number of active sites available to bind with sulfur. Under pyrolysis, carbon-based precursors can convert to either a mixture of graphitic or amorphous carbon materials. Localized sp2 carbon crystalline domains can be present in both materials. From the point of view of sulfur loading, the growth of sp2 crystals in lateral size can limit the active sites to bind with sulfur, and thus the gravimetric capacity of such sulfurized carbon cathodes.

Some embodiments extend the lithium storage capacity of sulfurized-carbon cathodes with enhanced porosity and molecular sulfur trapped within the pores. The resultant electrode material has two distinct forms of sulfur with different chemical structure, bonding, and physical properties. The first form of sulfur occurs as the sulfur atoms in the micro- and mesoporous sulfurized carbon, sulfur atoms that are covalently bonded to the carbonaceous matrix either directly or via other sulfur atoms. This bonded sulfur can be incorporated into the carbon structure in several forms, including thiophene-like structures (where sulfur atoms are part of carbon rings), as polysulfides (chains of sulfur atoms bonded to carbon), or as terminal groups attached to the carbon lattice. The second form of sulfur occurs as molecular sulfur, commonly as a ring of eight sulfur atoms (S₈), though other allotropes exist predominantly from S₂ to S₂₀. These sulfur molecules are adsorbed to the sulfurized carbon and trapped within the pores. The capture and adsorption of this elemental trapped sulfur slow the diffusion of soluble LiPS and thus enhance the cycle life of sulfur-based electrochemical cells that incorporate these electrodes. Sulfur beyond what can be trapped in the pore volume tends to deposit on external surfaces of the carbon materials and so does not benefit from the stabilizing effects of pore constraints.

Some embodiments modify the method of FIG. 1 to create sulfurized-carbon materials rich in micro- and mesopores for storing trapped sulfur. Addition of molecules to the polymer precursor, which might include variants of polyacrylonitrile, and synthesis process conditions, which includes mixing methods and treatment of the mixture precursors, induce the resulting sulfurized carbon material includes micro- and mesopores. The formation of micro- and mesopores can be facilitated in sulfurized carbon by modifying precursor polymers with co-monomers (molecules that are added to the chemical structure of the polymer). Chemicals, such as salts and solvents, can also be added to precursor polymers to expand cathode material and increase pore volume.

Sulfur can be loaded into the pores of sulfurized carbon in the heating program used for the precursor pyrolysis. By adjusting the temperature of the synthesis, sulfur vapors rich in smaller molecules (S₂ to S₄) can facilitate the loading of sulfur species in the newly formed pores of the sulfurized carbon. Pressure can further assist in the sulfur loading. After loading, the sulfur atoms covalently bonded to carbon atoms make up from twenty to fifty percent of the mass of the conductive framework and the SC particles, while the sulfur molecules are from six to thirty percent of this mass. Sulfur can also be added electrochemically using additives, such as lithium polysulfides, present in an electrolyte.

Sulfur utilization is important for understanding the efficiency, capacity, and overall performance of sulfur-based cathodes. Sulfur utilization refers to the fraction of sulfur that is actively participating in electrochemical reactions during cell discharge. The fraction of sulfur that participates in the reaction undergoes the following reaction: S+2Li→Li2S. High sulfur utilization is desirable as it indicates that a larger amount of the sulfur is being used to store and deliver energy, leading to higher specific capacities. Sulfur utilization can be measured indirectly as a function of the specific capacity of a cell that incorporates the cathode. The specific capacity, typically in milliamp-hours per gram, is compared to the theoretical capacity of sulfur to determine the utilization rate. In some embodiments, more than 70% of the sulfur, from both the sulfurized carbon and the trapped molecules, is utilized.

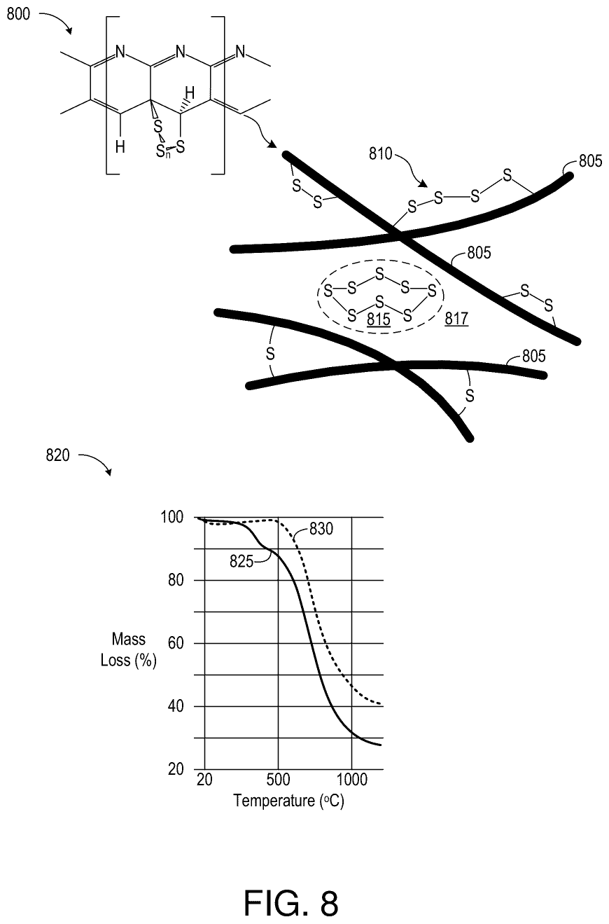

FIG. 8 includes a diagram 800 illustrating sulfurized-carbon structures 805 with covalently bonded sulfur 810 and an illustrative sulfur molecule 815 trapped in a pore 817 of the sulfurized carbon. Nitrogen is included in structures 805 as heteroatoms at a concentration of between five and twenty percent of the mass of the carbon atoms.

FIG. 8 also includes a thermogravimetric analysis (TGA) 820 characterizing sulfurized carbon material with bonded and trapped sulfur. TGA 820 includes separate curves 825 and 830 showing respective sulfur mass loss for trapped molecular sulfur and sulfur bonded to the carbon framework. These data were taken and averaged over more than ten batches. Cathode materials in some embodiments have about 40% bonded sulfur and 8-10% trapped sulfur molecules by weight. Other embodiments include 45% bonded and 25% trapped, 40% bonded and 30% trapped, and 40% bonded and 40% trapped.

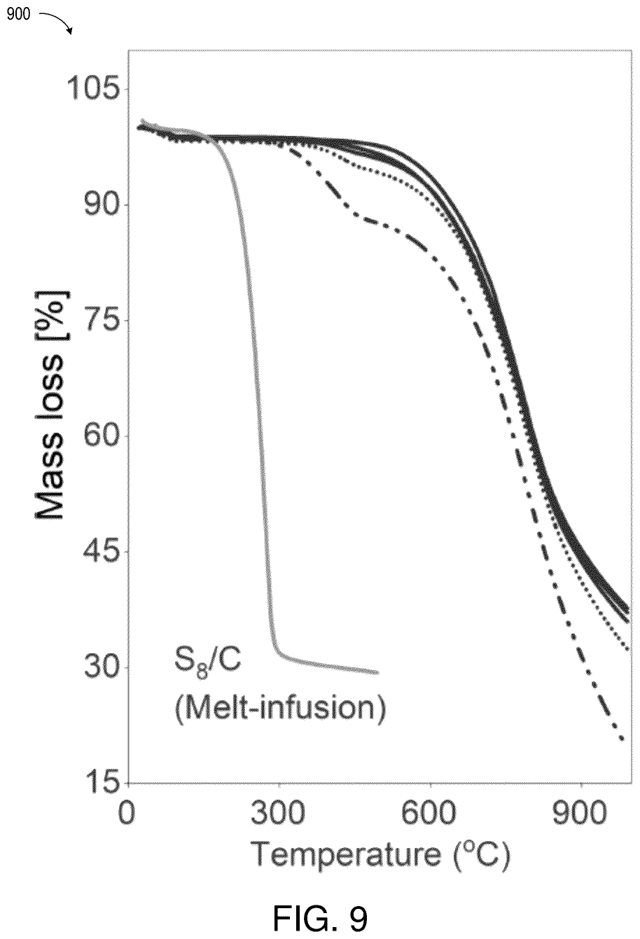

FIG. 9 is a chart 900 showing TGA characterizations of dual-sourced sulfur material in accordance with the foregoing examples in comparison with a sulfurized carbon baseline and elemental sulfur. These data were taken and averaged over more than ten batches.

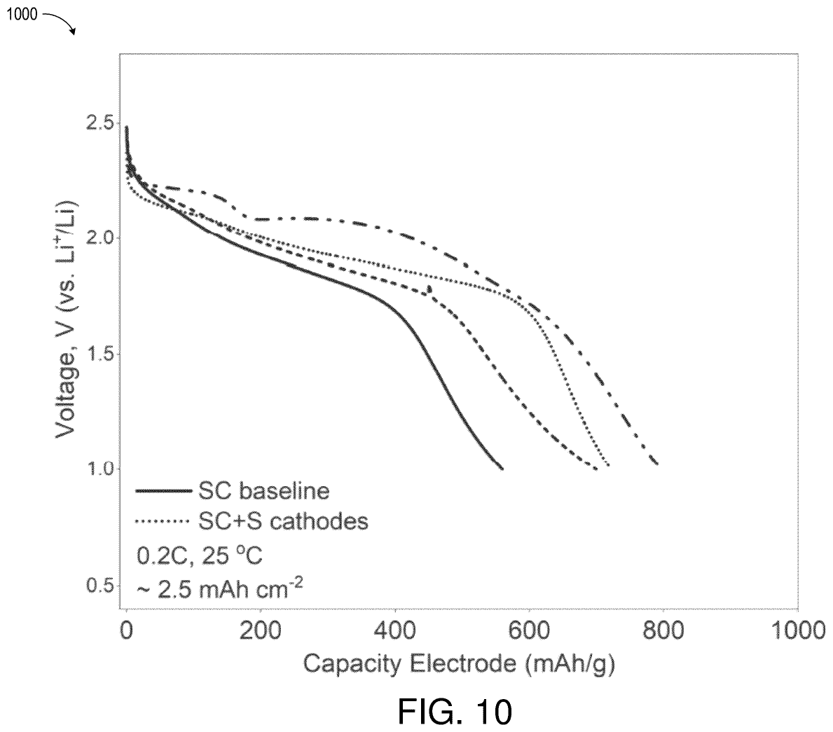

FIG. 10 is a chart 1000 showing specific capacity discharge curves for dual-sourced sulfur variations materials in comparison with the sulfurized-carbon baseline in a lithium-metal electrochemical cell. It can be observed that when the molecular sulfur component of the dual-sourced active material is increased, the voltage profile exhibits a hybrid shape that combines the dual plateau of common elemental sulfur electrodes and the slope curve with a knee of the sulfurized carbon electrodes making this dual-sourced electrode material unique due to its electrochemical behavior when it becomes lithiated. Furthermore, the new characteristics of this hybrid material are reflected in an enhanced specific capacity and energy density that overcomes any other variations of sulfurized carbons or sulfurized PAN derivatives.

The foregoing discussion focuses on electrochemical cells that employ lithium ions as charge carriers. Other alkali metals (e.g. sodium and potassium) can also be used. Other variations of these embodiments will be obvious to those of ordinary skill in the art. Therefore, the spirit and scope of the appended claims should not be limited to the foregoing description. Only those claims specifically reciting “means for” or “step for” should be construed in the manner required under the sixth paragraph of 35 U.S.C. §112.

1. An electrode comprising:
a conductive framework of nanofibers; and
particles of a carbonaceous matrix distributed within and covalently bonded to the framework of nanofibers, the particles including:
sulfurized carbon with sulfur atoms covalently bonded to carbon atoms;
pores defined within the sulfurized carbon; and
elemental sulfur molecules adsorbed to the sulfurized carbon and trapped within the pores.

2. The electrode of claim 1, wherein the sulfur molecules consist primarily of from S₂ to S₂₀ molecules.

3. The electrode of claim 1, wherein the sulfur atoms covalently bonded to the carbon atoms and the sulfur molecules are between twenty and fifty percent in mass of the conductive framework and the particles.

4. The electrode of claim 1, wherein the sulfur molecules trapped in pores are between six and forty percent in mass of the conductive framework and the particles.

5. The electrode of claim 1, the carbonaceous matrix further comprising nitrogen as heteroatoms.

6. The electrode of claim 5, wherein the mass of the nitrogen is between five and twenty percent of the mass of the carbon atoms and additional carbon atoms in the conductive framework.

7. The electrode of claim 1, wherein at least seventy percent of the sulfur in the sulfurized carbon and the sulfur molecules is reacted with at least one lithium atom.

8. The electrode of claim 1, wherein a first fraction of the sulfur atoms covalently bonded to carbon atoms are reacted with lithium and a second fraction different from the first fraction of the sulfur atoms of the sulfur molecules are reacted with lithium.

9. An electrode comprising:
porous particles of a carbonaceous matrix and having an average particle size and sulfur molecules adsorbed to the carbonaceous matrix and trapped within the pores, the carbonaceous matrix including sulfurized carbon of sulfur atoms covalently bonded to carbon atoms;
agglomerates of electrically conductive, intra-agglomerate filaments and the particles, the agglomerates having an average agglomerate size and the intra-agglomerate filaments having an average intra-agglomerate-filament width less than the average agglomerate size; and
electrically conductive extra-agglomerate filaments having an average extra-agglomerate-filament width greater than the average intra-agglomerate-filament width and an average extra-agglomerate length greater than the average agglomerate size.

10. The electrode of claim 9, wherein the intra-agglomerate filaments comprise carbon nanotubes.

11. The electrode of claim 9, the intra-agglomerate filaments having an average intra-agglomerate-filament length less than the average agglomerate size.

12. The electrode of claim 9, wherein the extra-agglomerate filaments comprise carbon nanotubes.

13. The electrode of claim 9, wherein the carbonaceous matrix includes nitrogen of at least five percent of the mass of the carbon atoms in the carbonaceous matrix and other carbon atoms in the filaments.

14. The electrode of claim 9, wherein the average extra-agglomerate-filament length is greater than five times the average agglomerate size.

15. The electrode of claim 9, wherein the intra-agglomerate-filament width is less than the average particle size.

16. An electrode comprising:
particles of a carbonaceous matrix, the particles including:
sulfurized carbon of sulfur atoms covalently bonded to carbon atoms;
pores defined within the sulfurized carbon; and
sulfur molecules adsorbed to the sulfurized carbon and trapped within the pores;
electrically conductive filaments;
agglomerates of the particles fused to a first set of the filaments, the first set of the filaments having an average filament length, an average filament width, and filament ends extending beyond the particles as anchor segments between adjacent ones of the particles; and
yarns of a second set of the filaments having an average yarn length greater than the average filament length and an average yarn width greater than the average filament width, wherein the yarns extend between the agglomerates.

17. The electrode of claim 16, wherein the average filament length is between fifty and one hundred microns.

18. The electrode of claim 17, wherein the average filament width is less than one micron.

19. The electrode of claim 18, wherein the average yarn width is greater than three microns.

20. The electrode of claim 16, wherein the sulfur atoms covalently bonded to the carbon atoms and covalently bonded to at least another sulfur atom, are from twenty to fifty percent in mass of the yarns and the particles.

21-37. (canceled)
